(19) United States
(12) Patent Application Publication
(10) Pub. No.: US 2025/0115043 A1
(43) Pub. Date: Apr. 10, 2025

(54) PRINTING METHODS USING PAPER SCALING FACTORS

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/480,720

(22) Filed: Oct. 4, 2023

(51) Int. Cl. B41F 33/00

(52) U.S. Cl. CPC B41F 33/0045

(57) ABSTRACT

Scaling factors are applied during printing operations to account for a change in the size of sheets. A sensor within a printing device captures an image to measure dimensions of a front surface of a target sheet of paper. A first scaling factor is determined for the front surface of the target sheet based on the measured dimensions as compared to target dimensions for the sheet. The sensor also captures an image to measure dimensions of a rear surface of the target sheet of a paper after ink or toner is applied to the sheet. A second scaling factor is determined for the rear surface of the target sheet based on the measured dimensions. The first scaling factor and the second scaling factor are applied to processing of subsequent sheets to meet the change in the size of sheets during printing operations.

### FIELD OF THE INVENTION

The present invention relates to a printing device having an optimized defect inspection system and methods to use paper scaling factors in printing operations.

### DESCRIPTION OF THE RELATED ART

Printing tolerance for production printing is much tighter when compared to the printing tolerance for office applications. This aspect may be especially true for the high quality printing expected from commercial print shops. A need to adjust the rendered image size to ensure printing may be performed accurately. This sort of adjustment is done usually by specifying magnification changes at either the paper catalog level or at the job, or queue, level. These approaches may require that the operator measure the paper, either before printing for the front surfaces, or after printing one side for the back surfaces. These approaches are labor intensive. They also may not be accurate as paper expansion or shrinkage may occur over time as the paper acclimates to the printing device's environment, such as when moisture from inkjet printing evaporates off the paper or other changes in in the printing operations occur.

### SUMMARY OF THE INVENTION

A method for performing printing operations is disclosed. The method includes measuring dimensions of a front surface of a first target sheet of a paper media using an inline sensor of a printing device. The method also includes determining a first scaling factor for the front surface of the first target sheet based on the measured dimensions of the front surface of the first target sheet. The method also includes measuring dimensions of a rear surface of the first target sheet of the paper media using the inline sensor. The method also includes determining a second scaling factor for the rear surface of the first target sheet based on the measured dimensions of the rear surface of the first target sheet. The method also includes applying the first scaling factor for the front surface of the first target sheet and the second scaling factor for the rear surface of the first target sheet to a print job using the paper media.

The method further includes receiving a subsequent sheet to be printed using the paper media. The method further includes applying the first scaling factor to the front surface of the subsequent sheet and the second scaling factor to the rear surface of the subsequent sheet. The method further includes printing the subsequent sheet. The method further includes measuring dimensions of the front surface of the subsequent sheet. The method further includes measuring dimensions of the rear surface of the subsequent sheet. The method further includes updating the first scaling factor based on the measured dimensions of the front surface of the subsequent sheet or the second scaling factor based on the measured dimensions of the rear surface of the subsequent sheet.

A method for performing printing operations at a printing device is disclosed. The method includes processing a print job at a digital front end (DFE) for the printing device by applying a first scaling factor. The method also includes monitoring a sheet dimension for a sheet within the print job. The method also includes detecting that the sheet dimension does not meet a requirement for the first scaling factor. The method also includes pausing processing of the print job. The method also includes determining a second scaling factor based on the sheet dimension of the sheet. The method also includes resuming processing of the print job. The method also includes applying the second scaling factor at the DFE for processing the print job.

A method for managing printing operations of a print job is disclosed. The method includes measuring dimensions of a front surface of a first target sheet of a paper media using an inline sensor of a printing device. The method also includes determining a front scaling factor for the front surface of the first target sheet based on the measured dimensions of the front surface of the first target sheet. The method also includes printing the first target sheet having a first amount of ink coverage. The method also includes determining a first rear scaling factor based on measured dimensions for a rear surface of the first target sheet having the first amount of ink coverage. The method also includes printing the first target sheet having a second amount of ink coverage. The method also includes determining a second rear scaling factor based on measured dimensions for a rear surface of the first target sheet having the second amount of ink coverage. The method also includes storing the front scaling factor, the first rear scaling factor, and the second rear scaling factor. The method also includes applying the front scaling factor for the front surface of a printed sheet and a selected rear scaling factor for the rear surface of the printed sheet based on an ink coverage for the front surface. The first rear scaling factor or the second rear scaling factor is selected on the ink coverage.

A method for managing printing operations is disclosed. The method includes printing at least one sheet of a print job at a printing device. The method also includes measuring dimensions of a front surface of the at least one sheet. The method also includes determining a first scaling factor for the front surface of the at least one sheet based on the measured dimensions of the front surface. The method also includes measuring dimensions of a rear surface of the at least one sheet. The method also includes determining a second scaling factor for the rear surface of the at least one sheet based on the measured dimensions of the rear surface. The method also includes applying the first scaling factor for the front surface and the second scaling factor for the rear surface of a subsequent copy of the print job at the printing device.

### BRIEF DESCRIPTION OF THE DRAWINGS

Various other features and attendant advantages of the present invention will be more fully appreciated when considered in conjunction with the accompanying drawings.

FIG. 1 illustrates a schematic diagram of a printing device for printing documents according to the disclosed embodiments.

FIG. 2 illustrates a plan view of a recording unit according to the disclosed embodiments.

FIG. 3 illustrates a configuration around the conveying path of the paper from a paper feed cassette to a second conveying unit via a first conveying unit according to the disclosed embodiments.

FIG. 4 illustrates a block diagram showing a hardware configuration of a main part of the printing device according to the disclosed embodiments.

FIG. 5 illustrates a block diagram of a control unit within the printing device according to the disclosed embodiments.

FIG. 6 illustrates a block diagram of an inline sensor and the control unit generating scaling factors for printing operations according to the disclosed embodiments.

FIG. 7 illustrates a block diagram of determining and using multiple scaling factors for the rear surface of sheet according to the disclosed embodiments.

FIG. 8 illustrates a flowchart for determining scaling factors for use in printing operations according to the disclosed embodiments.

FIG. 9 illustrates

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments include a system that uses the inline sensors found in printing devices. The inline sensors are configured to automatically determining scaling factors in order to eliminate this as a task that operators perform. The inline sensors also are configured to improve paper scaling by making the operation more granular. The inline sensors also are configured to improve paper scaling by continually updating scaling factors and triggering updates in the raster image processing (RIP) system as needed.

The disclosed embodiments provide the operator with the option to ascertain and persistently store scaling factors for different papers. To determining scaling factors for a paper, the operator would select a paper from the media catalog and start a measurement process. The printing device would feed the paper and use the inline sensor to measure the width and length of the paper. The disclosed embodiments then compare actual dimensions versus the nominal dimensions of the paper to determine the scaling factors for the front of the sheets for the selected media.

The disclosed embodiments also may print three targets with different amounts of ink coverage, such as 20%, 50%, and 80% for a colorant, or 80%, 200%, or 320% for all four colorants. The disclosed embodiments would then compare actual dimensions versus the nominal dimensions of the paper to determine the scaling factors for the back of the sheets for the selected media for low, mid, and high ink coverage.

As part of job processing, the DFE performs a preflight check to determine whether the job has low, mid, or high ink coverage levels. The disclosed embodiments then raster image processes the front and back surfaces using the relevant scaling factor for the selected paper given the job's toner or ink coverage.

Alternatively, the operator may proof the job in order to determine job-specific scaling factors, such as for a proof and hold print job. The disclosed embodiments may print one copy of the job and measure the actual dimensions of the front and rear surfaces of the job. The disclosed embodiments will determine job-specific scaling factors for the front and rear surfaces of the job. The disclosed embodiments raster image processes each document page based on the measured scaling factors for the job.

For long jobs, the disclosed embodiments may continuously monitor paper dimensions. If the dimensions change beyond certain thresholds, then the disclosed embodiments may trigger re-raster image processing of the document in order to adjust the dimensions used for raster imaging processing the job. This feature may be done in combination with the proof and hold option or it may be done as part of nominal job printing.

The disclosed embodiments, therefore, provide multiple scaling factors for different levels of ink or toner coverage. It also does this for different papers. The disclosed embodiments provide more accurate print reproduction for different types of jobs. The ability to print a proof in order to determine scaling factors provides more accurate scaling that considers both the exact scaling for the selected job and the exact dimensions of the paper that changes based on how the paper is stored and how long the paper has been in the same environment as the printing device.

The disclosed embodiments also provide the ability to use different scaling factors per document page to provide a more accurate print reproduction. The disclosed embodiments also provide the ability to adjust scaling factors while printing the job. This feature also provides accurate reproduction that adjusts as paper acclimates to the environment of the printing device.

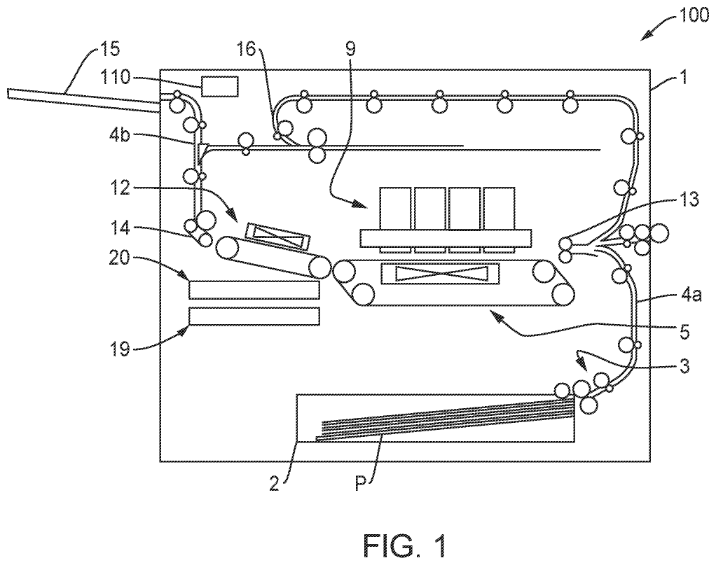

FIG. 1 depicts a schematic diagram of a printing device 100 for printing documents according to the disclosed embodiments. Printing device 100 includes a paper feed cassette 2 that is a paper storage unit. Paper feed cassette 2 may be arranged at the lower inner portion of printing device body 1. Paper P, which is an example of a recording medium, is housed inside paper feed cassette 2.

A paper feeding device 3 is arranged on the downstream side in the paper conveying direction of paper feed cassette 2, or, in other words, above the right side of paper feed cassette in FIG. 1. By this paper feeding device 3, paper P is directed toward the upper right of paper feed cassette 2 in FIG. 1, and is separated and fed out one sheet at a time.

Printing device 100 includes a first paper conveying path 4a in the inner portion thereof. First paper conveying path 4a is located on the upper right side, which is the paper feed direction, with respect to paper feed cassette 2. The paper P fed out from paper feed cassette 2 is conveyed vertically upward along the side surface of printing device body 1 by first paper conveying path 4a.

A registration roller pair 13 is provided at the downstream end of first paper conveying path 4a in the paper conveying direction. Further, a first conveying unit 5 and a recording unit 9 are arranged immediately downstream of registration roller pair 13 in the paper conveying direction. The paper P fed out from paper feed cassette 2 reaches registration roller pair 13 via first paper conveying path 4a. Registration roller pair 13 feeds the paper P toward first conveying unit 5 while correcting diagonal feeding of the paper P and measuring the timing with the ink ejection operation performed by recording unit 9.

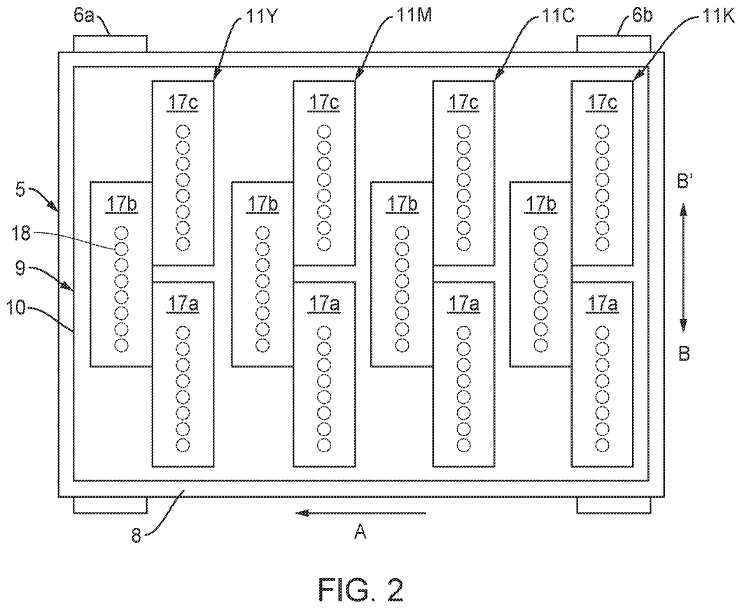

The paper P fed to first conveying unit 5 is conveyed to a position facing recording unit 9, especially recording heads 17a, 17b, and 17c, disclosed below, by a first conveyor belt 8, shown in FIG. 2. An image is recorded on the paper P by ejecting ink from recording unit 9 onto the paper P. At this time, the ejection of ink in recording unit 9 is controlled by control unit 110 in the inner portion of printing device 100. Control unit 110 includes, for example, a central processing unit (CPU). Control unit 110 also may be known as a digital front end (DFE) for printing device 100.

Second conveying unit 12 is arranged on the downstream side, or left side in FIG. 1, of first conveying unit 5 in the paper conveying direction. The paper P on which the image is recorded by recording unit 9 is sent to second conveying unit 12. The ink ejected onto the surface of the paper P is dried while passing through second conveying unit 12.

A decurler unit 14 is provided on the downstream side of second conveying unit 12 in the paper conveying direction and near the left side surface of printing device body 1. The paper P whose ink has been dried by second conveying unit 12 is sent to decurler unit 14 in order to correct curling that has occurred in the paper P.

A second paper conveying path 4b is provided on the downstream side, or upper side in FIG. 1, of decurler unit 14 in the paper conveying direction. In a case where double-sided recording is not performed, the paper P that has passed through decurler unit 14 passes through second paper conveying path 4b and is discharged to paper discharge tray 15 provided in the outer portion of the left side surface of printing device 100.

A reverse conveying path 16 for performing double-sided recording is provided in the upper portion of printing device body 1 above recording unit 9 and second conveying unit 12. In a case of performing double-sided recording, the paper P that has passed through second conveying unit 12 and decurler unit 14 after recording on one surface, or the first surface, of the paper P is sent to reverse conveying path 16 through second paper conveying path 4b.

The conveying direction of the paper P sent to reverse conveying path 16 is subsequently switched for recording on the other surface, or the second surface, of the paper P. Then, the paper P passes through the upper portion of printing device body 1 and is sent toward the right side, and is sent again, via registration roller pair 13, to first conveying unit 5 with the second surface thereof facing upward. In first conveying unit 5, the paper P is conveyed to a position facing recording unit 9, and an image is recorded on the second surface by ejecting ink from recording unit 9. The paper P, after double-sided recording, is discharged to paper discharge tray 15 via second conveying unit 12, decurler unit 14, and second paper conveying path 4b, in this order.

Moreover, a maintenance unit 19 and a cap unit 20 are arranged below second conveying unit 12. When executing purging, maintenance unit 19 moves horizontally below recording unit 9, wipes the ink extruded from the ink ejection port of the recording head, and collects the wiped ink. Note that purging refers to an operation of forcibly extruding the ink from the ink ejection port of the recording head in order to discharge thickened ink, foreign matter, and air bubbles in the ink ejection port. Cap unit 20 moves horizontally below recording unit 9 when capping the ink ejection surface of the recording head, moves further upward, and is attached to the lower surface of the recording head.

FIG. 2 depicts a plan view of recording unit 9 according to the disclosed embodiments. Recording unit 9 includes a head housing 10 and line heads 11Y, 11M, 11C, and 11K. Line heads 11Y to 11K are held in head housing 10 at a height at which specific spacing, for example 1 mm, is formed with respect to the conveying surface of an endless first conveyor belt 8 that spans around a plurality of rollers including a drive roller 6a, a follower roller 6b, and another roller 7.

Line heads 11Y to 11K have a plurality of recording heads 17a, 17b, and 17c, respectively. Recording heads 17a to 17c are arranged in a zigzag pattern along the paper width direction (direction of arrow BB′) orthogonal to the paper conveying direction (direction of arrow A). Recording heads 17a to 17c have a plurality of ink ejection ports 18 (nozzles). Each ink ejection ports 18 are arranged side by side at equal intervals in the width direction of the recording head, or in other words, the paper width direction (direction of arrow BB′). From line heads 11Y to 11K, ink of each color of yellow (Y), magenta (M), cyan (C), and black (K) is respectively ejected via ink ejection ports 18 of recording heads 17a to 17c toward the paper P that is conveyed by first conveyor belt 8.

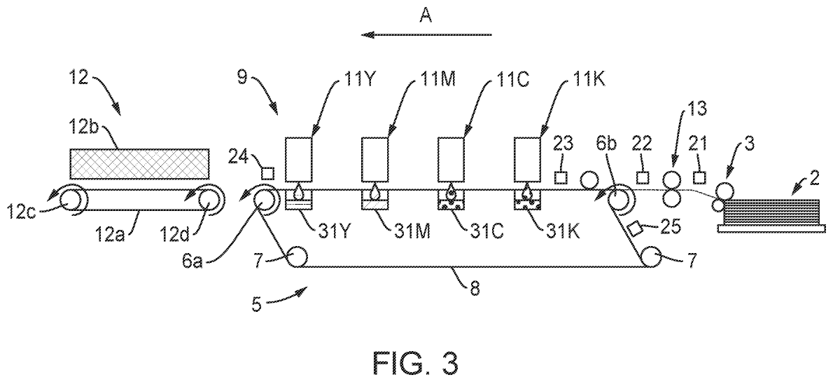

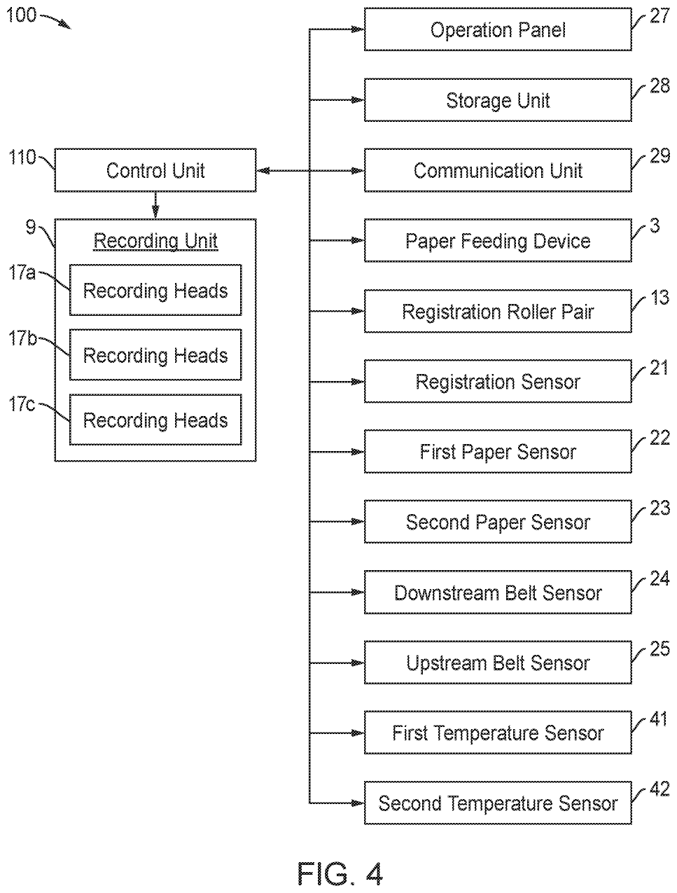

FIG. 3 depicts a configuration around the conveying path of the paper P from paper feed cassette 2 to second conveying unit 12 via first conveying unit 5 according to the disclosed embodiments. FIG. 4 depicts a block diagram showing a hardware configuration of a main part of printing device 100 according to the disclosed embodiments. Printing device 100, in addition to the configuration disclosed above, further includes a registration sensor 21, a first paper sensor 22, a second paper sensor 23, belt sensors 24 and 25, first temperature sensor 41, and second temperature sensor 42.

Registration sensor 21 detects the paper P conveyed from paper feed cassette 2 by paper feeding device 3 and sent to registration roller pair 13. Control unit 110 is able to control the rotation start timing of registration roller pair 13 based on the detection result of registration sensor 21. For example, control unit 110 is able to control the supply timing of paper P after the skew (inclination) correction by registration roller pair 13 to first conveyor belt 8 based on the detection result of registration sensor 21.

First paper sensor 22 is a line sensor that detects the position in the width direction of the paper P sent from registration roller pair 13 to first conveyor belt 8. Based on the detection result of first paper sensor 22, control unit 110 is able to record an image on the paper P by causing ink to be ejected from ink ejection openings 18 of the ink ejection ports of recording heads 17a to 17c of line heads 11Y to 11K that correspond to the width of the paper P.

Second paper sensor 23 is a sensor for detecting the position in the conveying direction of the paper P conveyed by first conveyor belt 8. Second paper sensor 23 is located on the upstream side in the paper conveying direction of recording unit 9 and on the downstream side of first paper sensor 22. Based on the detection result of second paper sensor 23, control unit 110 is able to control the ink ejection timing for the paper P reaching the position facing line heads 11y to 11K, and recording heads 17a to 17c, by first conveyor belt 8.

Belt sensors 24 and 25 detect the positions of a plurality of opening portion groups provided on first conveyor belt 8. Belt sensors 24 and 25 are detection sensors that detect the passage of at least one of the opening groups due to the running of first conveyor belt 8. Belt sensor 24 is located on the downstream side of recording unit 9 in the paper conveying direction, or the running direction of first conveyor belt 8. Belt sensor 25 is located at a position between follower roller 6b and other roller 7 where first conveyor belt 8 is stretched around follower roller 6b and other roller 7. Follower roller 6b is located on the upstream side of recording unit 9 in the running direction of first conveyor belt 8. Note that belt sensor 24 also has the same function as second paper sensor 23. Control unit 110 is able to control registration roller pair 13 so as to supply paper P to first conveyor belt 8 at a specific timing based on the detection result of belt sensor 24 or 25.

The positions of the paper P are detected by a plurality of sensors (second paper sensor 23 and belt sensor 24), and the positions of the opening portion groups of first conveyor belt 8 are detected by a plurality of sensors (belt sensors 24 and 25), and, as a result, it is possible to correct errors in the detected positions and detect an abnormality.

First paper sensor 22, second paper sensor 23, and belt sensors 24 and 25 disclosed above may be configured by a CIS sensor. Marks corresponding to the position of opening portion groups are formed at the end portion in the width direction of first conveyor belt 8 and belt sensors 24 and 25 detect the marks, whereby the positions of the opening portion groups may be detected. CIS sensors may be image sensors that are almost in direct contact with the object to be scanned. A CIS sensor typically includes a linear array of detectors, covered by focusing lenses and flanked by red, green, and blue light emitting diodes (LEDs) for illumination.

First temperature sensor 41 is a sensor that detects the ambient temperature of printing device 100, and includes, for example, a non-contact temperature sensor such as a radiation thermometer or the like, and is provided on the outer surface of printing device main body 1. Second temperature sensor 42 is a sensor that detects the temperature of recording heads 17a to 17c, and includes, for example, a contact type temperature sensor such as a thermistor, a resistance temperature detector, a thermocouple, and the like. Control unit 110 can control the amount of ink ejected from each ink ejection port 18 of recording heads 17a to 17c based on the detection result of first temperature sensor 41 or second temperature sensor 42.

Printing device 100 includes an operation panel 27, a storage unit 28, and a communication unit 29. Operation panel 27 is an operation unit for receiving various setting inputs from an operator. For example, the operator may operate operation panel 27 to input information about the size of the paper P set in paper feed cassette 2, or, in other words, the size of the paper P conveyed by first conveyor belt 8. Storage unit 28 is a memory that stores an operation program of control unit 110 and also stores various types of information, and includes a Read Only Memory (ROM), a Random Access Memory (RAM), a non-volatile memory, and the like. Information sent by operation panel 27 is stored in storage unit 28. Communication unit 29 is a communication interface, such as a personal computer for transmitting and receiving information to and from printing device 100. For example, when the operator operates communication unit 29 and transmits a print command together with image data to printing device 100, the image data and the print command are inputted to printing device 100 via communication unit 29. In printing device 100, an image may be recorded on the paper P by control unit 110 controlling recording heads 17a to 17c to eject ink based on the image data. Image data also may be stored temporarily in storage unit 28.

Referring to FIG. 3, printing device 100 has ink receiving units 31Y, 31M, 31C, and 31K on the inner peripheral surface side of first conveyor belt 8. When recording heads 17a to 17c are made to execute flushing, ink receiving units 31Y to 31K receive and collect the ink that has been ejected from recording heads 17a to 17c and passed through the opening portions of opening portion groups of first conveyor belt 8. Ink receiving units 31Y to 31K are provided at positions facing recording heads 17a to 17c of line heads 11Y to 11K via first conveyor belt 8. The ink collected by ink receiving units 31Y to 31K is sent to, for example, a waste ink tank and disposed of, however, also may be reused without being disposed of.

Flushing is the ejection of the ink at a timing different from the timing that contributes to image formation or recording on the paper P, and is for the purpose of reducing or preventing clogging of ink ejection ports 18 due to ink drying. The execution of flushing in the recording heads 17a to 17c is controlled by control unit 110. Second conveying unit 12 is configured to include a second conveyor belt 12a and a dryer 12b. Second conveyor belt 12a is stretched around two drive rollers 12c and a follower roller 12d. The paper P that is conveyed by first conveying unit 5 and on which an image has been recorded by ink ejected by recording unit 9 is conveyed by second conveyor belt 12a and dried by dryer 12b while being conveyed to decurler unit 14.

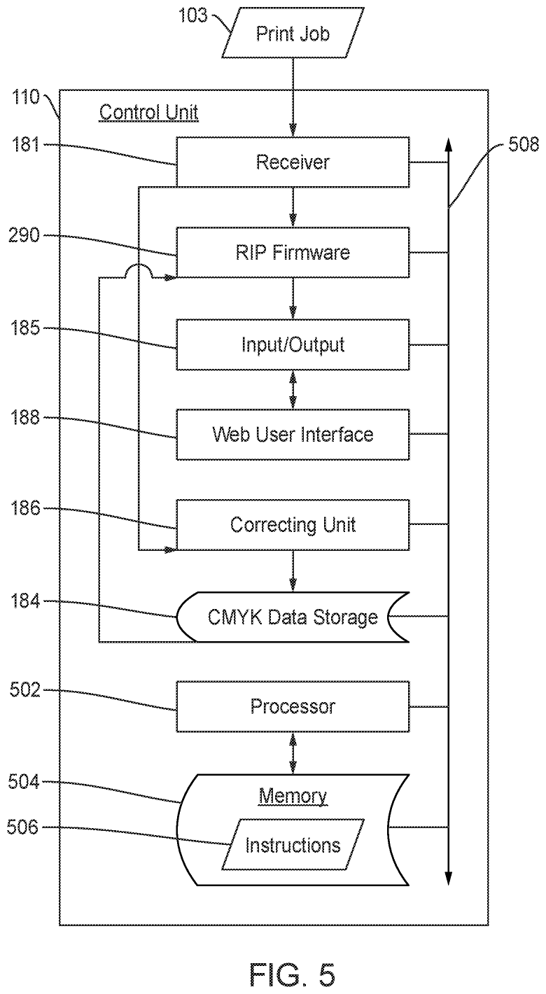

FIG. 5 depicts a block diagram of control unit 110 according to the disclosed embodiments. Control unit 110 includes a receiver 181, a RIP firmware 290, a CMYK data storage 184, an input/output connector 185, and a correcting unit 186. Additional components within control unit 110 may be implemented, as disclosed below.

Receiver 181 receives print job 103 received within printing device 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing device 100 or a printing system via input/output connector 185. The print condition information and the print medium type, as well as the rendering data, may be transmitted to a selected printing device within the printing system. As disclosed above, the rendered data may be in a file format acceptable for a printing device such that the print job is provided directly to the print engine of the printing device.

Control unit 110 also includes web user interface 188 that may communicate with other devices within the printing system, if it is located at a separate device, using, for example, input/output connector 185. Web user interface 188, or web application, allows a user of the control units of other printing devices to interact with content or software running on control unit 110.

It should be noted that control unit 110 also may be referred to as a digital front end (DFE) for printing device 100. A DFE may serve as a controller does performs functions as specified below to managing printing operations. Thus, control unit, or DFE, 110 also include a processor 502 connected to a memory 504. Instructions 506 stored in memory 504 are executed on processor 502, which, in turn, configures control unit 110 to perform specified operations. For example, instructions 506 may cause processor 502 to have an inline sensor within printing device 100 measure the dimensions of a paper.

Processor 502 and memory 504 may be connected by a bus 508. Bus 508 also may be connected to the other components within control unit 110. Control unit 110 also may store scaling factors, disclosed below, in memory 504 along with color printing resources and other data related to the disclosed embodiments.

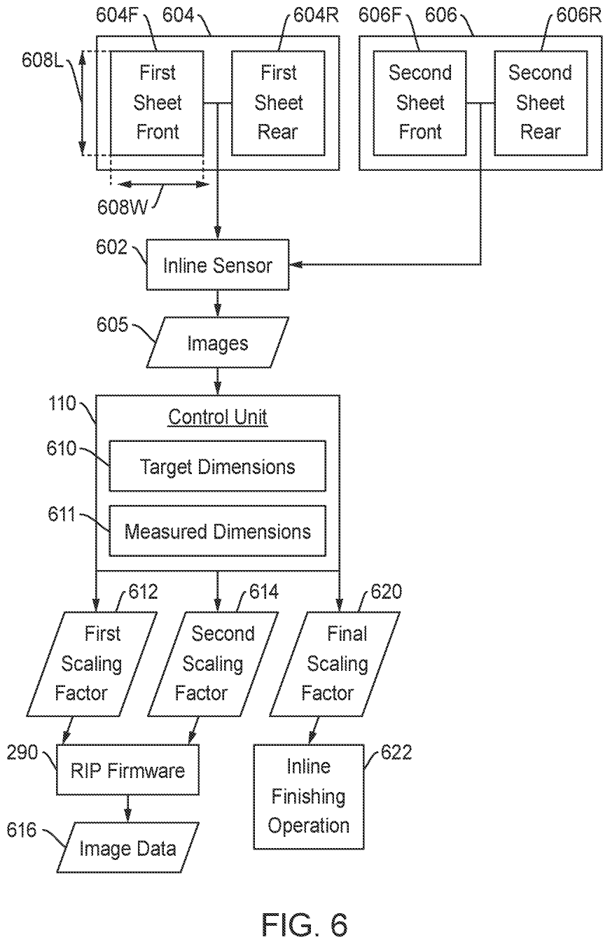

FIG. 6 depicts a block diagram of an inline sensor 602 and control unit 110 generating scaling factors for printing operations according to the disclosed embodiments. Inline sensor 602 may refer to any of the sensors disclosed within FIGS. 1-4, such as first paper sensor 22, second paper sensor 23, or belt sensors 24 and 25. Inline sensor 602 is capable of capturing an image of a sheet of paper as it moves through printing device 100. Inline sensor 602 also may refer to these sensors in the collective in that one sensor may capture a first image of a sheet of paper while another sensor captures a second image of the sheet.

Inline sensor 602 preferably is a contact image sensor (CIS). These sensors are used to detect the cross process position of the sheet. Referring back to FIG. 4, first paper sensor 22 may be used for sheets of paper coming from the feeder. Second paper sensor 23 may be used for sheets of paper coming from the duplex path. Either sensor may be used to determine the width of the sheet. Thus, inline sensor 602 captures an image of the sheet of paper for determining the exact position. This image also may be used to determine dimensions, such as the width, of the sheet of paper.

Further, inline sensor 602 may detect the lead and trail edges of the sheet of paper. That information, along with information from another sensor detecting spokes on a sprocket connected to the rollers may allow the disclosed embodiments to determine dimensions, such as length, of the sheet of paper. The disclosed embodiments may sense the lead and trail edges of the sheet and the exact travel speed of the sheet to calculate the length for the sheet.

For example, a first sheet 604 may be fed through printing device 100, as disclosed above. Inline sensor 602 captures an image 605 that provide dimensions of the surfaces of the sheet. For example, inline sensor 602 may capture an image 605 of first sheet front 604F and an image 605 of first sheet rear 604R. Using images 605, measured dimensions 611 are determined for first sheet front 604F. Measured dimensions 611 may include dimension 608L, which is the length of first sheet front 604F. It also includes dimension 608W, which is the width of first sheet rear 604R.

Control unit 110 may determine measured dimensions 611 for first sheet front 604F from image 605 captured by inline sensor 602. Measured dimensions 611 are compared to target dimensions 610 for a sheet of the paper media of first sheet 604. For example, first sheet 604 be a specific a paper media, such as coated white paper, having target dimensions 610 of 8.5 by 11 inches. The printing system of printing device 100 would like finished print jobs to have the same look even if the size of the sheets of paper media vary during printing operations. As disclosed above, such variation would occur during printing operations, especially for long print jobs.

For example, measured dimensions from image 605 of first sheet front 604F may show a slight variation from target dimensions 610. This variation may be used to generate first scaling factor 612. First scaling factor 612 may be applied to the front surface of the paper media of first sheet 604 for subsequent printing of print job 103 or other print jobs. Using the above example, measured dimensions 611 may indicate that first sheet 604 expanded by 2% after being in printing device 100 or within an environment close to the printing device. Thus, first scaling factor 612 may adjust image data 616 generated by RIP firmware 290 by 2% to properly fit onto sheets of the paper media of first sheet 604. A printed sheet would match one that is printed at another printing device that may not have any variation from target dimensions 610.

The disclosed embodiments also may determine a second scaling factor 614 for first sheet rear 604R. First sheet rear 604R may be captured by inline sensor 602 after printing is done on first sheet front 604F. Thus, dimension 608L and dimension 608W for first sheet rear 604R may differ from the ones determined for first sheet front 604F. Inline sensor 602 captures image 605 of first sheet rear 604R and provides it to control unit 110.

In some embodiments, the size of the fronts of the sheets may be different versus the specified size due to cutting variations or due to the environment in which the sheets of paper are stored. Papers in high humidity environments will tend to expand and papers in higher temperature environments tend to shrink. As the paper adjusts to the environment of printing device 100, it will change in size and dimensions. The amount of expansion or shrinkage for width and length will depend on the direction of the fibers in the paper. For example, long grain paper will not expand in the same direction as short grain paper.

Humidity and temperature may cause the sheet size to change. This feature also is the reason the size of the sheet of paper will be different when printing on the rear side. When printing on the front surface using ink, this operation is adding water to the sheet that will cause it to expand. When the rear surface is printed, the sheet may be larger. Similarly, when printing on the front surface of a sheet of paper using toner, heat is added, especially for heavier papers, that takes water out of the sheet of paper causing it to shrink. The rear surface will be smaller during printing. After printing, the sheet of paper may acclimate to the environment and slowly go back to its original size.

Control unit 110 compares measured dimensions 611 for first sheet rear 604R to target dimensions 610 to determine second scaling factor 614. If first scaling factor 612 is 2%, then second scaling factor 614 may be 3%, which also must be accounted for in generating image data 616 for print job 103. Second scaling factor 614 also may depend on the amount of ink or toner used to print first sheet front 604F. This relationship is disclosed in greater detail below.

First sheet 604 may be referred to as a target sheet, used to generate first scaling factor 612 and second scaling factor 614 for the paper media of the target sheet. Control unit 110 may store first scaling factor 612 and second scaling factor 614 for use whenever a print job calls for the paper media of first sheet 604. For a print job having multiple pages to be used in more than one copy, scaling factors may be determined for each sheet. For example, second sheet 606 also may be analyzed by capturing images 605 of second sheet front 606F and second sheet rear 606R. A separate first scaling factor 612 and second scaling factor 614 may be determined for second sheet 606 and stored within control unit 110. When copies of print job 103 are printed, the first set of scaling factors 612 and 614 may be applied to first sheet 604 and the second set of scaling factors 612 and 614 applied to second sheet 606 and so on for each sheet of the print job.

A final scaling factor 620 also may be determined. If a belt sensor 24 or 25 is acting as inline sensor 602, then it may capture first sheet 604 after it is printed on both sides. In other words, first sheet 604 is done going through printing device 100 and may have been subject to more actions to cause expansion or contraction of first sheet 604. Inline sensor 602 captures images of first sheet front 604F and first sheet rear 604R. Measured dimensions 611 of these images 605 may be used to determine final scaling factor 620. Final scaling factor 620 may be used to adjust an inline finishing operation 622. In some embodiments, only measured dimensions 611 of first sheet front 604F is used to determine final scaling factor 620. Alternatively, measured dimensions 611 may consider any images 605 of first sheet rear 604R. For example, measured dimensions 611 may take an average of the measured dimensions of the front and rear of first sheet 604.

If print job 103 is a long print job requiring many pages or copies, the disclosed embodiments may monitor measured dimensions 611 of the sheets of the print job. If measured dimensions 611 of one or more sheets changes beyond a certain threshold, then control unit 110 may pause operations to recalculate the scaling factors to account for the change. The recalculation also may trigger redoing the raster image processing of print job 103 with the updated scaling factors.

For example, first scaling factor 612 and second scaling factor 614 are generated based on measured dimensions for first sheet 604. During the printing operations of print job 103, second sheet 606 is considered. Inline sensor 602 captures images of second sheet front 606F or second sheet rear 606R. Measured dimensions 611 are determined for second sheet 606. These dimensions may be higher than 5% of target dimensions 610, which is a threshold to trigger recalculation of the scaling factors. Thus, second sheet 606 may be used as a subsequent sheet to determine first scaling factor 612 and second scaling factor 614.

Control unit 110 may pause printing of print job 103 at printing device 100 while the new scaling factors are determined. Once first scaling factor 612 and second scaling factor 614 are updated, RIP firmware 290 may rerun raster image processing for print job 103 to apply the updated scaling factors. Subsequent pages also may be monitored to further update the scaling factors as needed. Further, if measured dimensions 611 for subsequent sheets of print job 103 fall below a threshold, then the scaling factors also may be updated or return to the previous scaling factors along with reprocessing the print job within the RIP firmware.

In some embodiments, inline sensor 602 may not be used. Instead, printing device 100 may print first sheet 604. An operator may measure dimension 608L and dimension 608W of first sheet 604 to determine measured dimensions 611. Alternatively, printing device 100 may use another component measure the dimensions of first sheet 604. Measured dimensions 611 then may be used by control unit 110 to determine first scaling factor 612 and second scaling factor 614. These actions may be used for a proof and hold job where a first copy is printed of print job 103 and used to proof the job. As part of the proof, measured dimensions 611 for each sheet may be captured and used to determine scaling factors for each sheet of the print job.

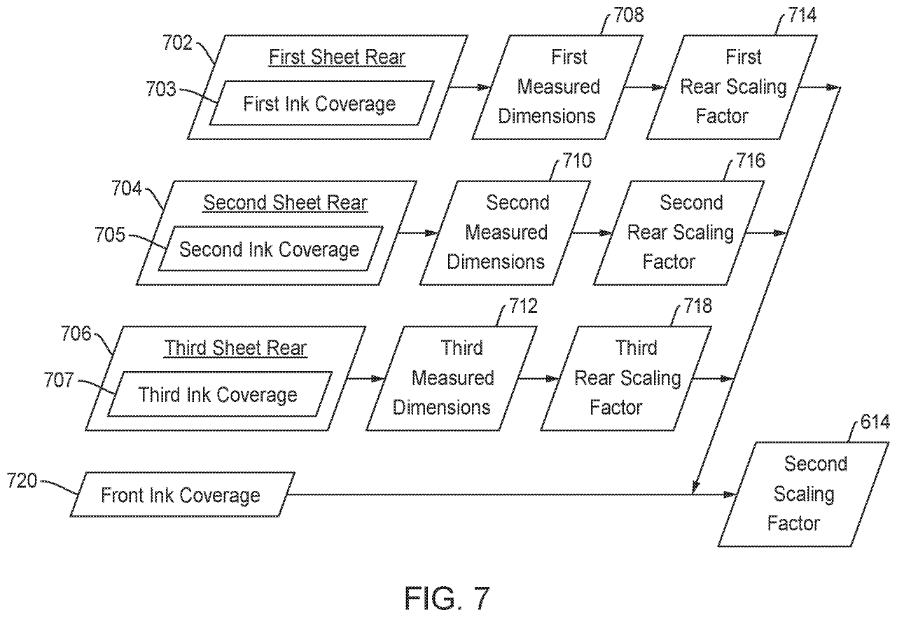

FIG. 7 depicts a block diagram of determining and using multiple scaling factors for the rear surface of sheet according to the disclosed embodiments. As noted above, first scaling factor 612 for first sheet front 604F is determined before any ink or toner is placed on first sheet 604. For simplicity, the term ink may be used in disclosing the embodiments, which also includes the use of toner within printing device 100. For example, ink coverage also may refer to toner coverage.

A certain amount of ink may be placed on first sheet front 604F. The ink may cause first sheet 604 to change dimensions based on the ink within the paper media and other factors. More ink may cause more change to the dimensions of first sheet 604. Thus, measured dimensions 611 for first sheet rear 604R may vary depending on the amount of ink coverage placed on first sheet front 604F.

The disclosed embodiments may print three targets of first sheet 604 with different amounts of ink coverage, such as low, medium or mid, and high coverage. Scaling factors may be determine for the rear surfaces of the target sheets according to the ink coverage. A scaling factor may be selected based on the amount of ink coverage for the front surface of a sheet of the paper media of the target sheet.

Thus, first sheet rear 702, second sheet rear 704, and third sheet rear 706 may be considered. First sheet rear 702 is not to be confused with first sheet rear 604R disclosed above, although first sheet rear 604R may correspond with the first target sheet used in determining second scaling factor 614. Each sheet rear corresponds to an amount of ink coverage on the front surface of the respective target sheet.

First sheet rear 702 includes first ink coverage 703. First ink coverage 703 may correspond to a low amount of ink coverage, such as 20% of a single colorant or 80% of all four colorants, used on the front surface of the target sheet for first sheet rear 702. Second sheet rear 704 includes second ink coverage 705. Second ink coverage 705 may correspond to a medium amount of ink coverage, such as 50% of a single colorant or 200% of all four colorants, used on the front surface of the target sheet for second sheet rear 704. Third sheet rear 706 includes third ink coverage 707. Third ink coverage 708 may correspond to a high amount of ink coverage, such as 80% of a single colorant or 320% of all four colorants, used on the front surface of the target sheet for third sheet rear 706.

Inline sensor 602 may capture an image of each sheet rear to determine the corresponding measured dimensions for each target sheet. First measured dimensions 708 are determined based on a captured image 605 of first sheet rear 702. Second measured dimensions 710 are determined based on a captured image 605 of second sheet rear 704. Third measured dimensions 712 are determined based on a captured image 605 of third sheet rear 706. These measured dimensions then are used to determine rear scaling factors for each target sheet having different ink coverages.

The measured dimensions are compared to target dimensions 610 for the target sheet. The result is the rear scaling factor for that target sheet having the specified ink coverage. The term “rear scaling factor” relates to second scaling factor 614 disclosed above. According to the disclosed embodiments, first rear scaling factor 714 is determined based on first measured dimensions 708 for first sheet rear 702 corresponding to first ink coverage 703. Second rear scaling factor 716 is determined based on second measured dimensions 710 for second sheet rear 704 corresponding to second ink coverage 705. Third rear scaling factor 718 is determined based on third measured dimensions 712 corresponding to third ink coverage 707. Control unit 110 may store the scaling factors along with the corresponding amount of ink coverage.

For example, first ink coverage 703 may be a low amount of ink coverage that results in a 1% change in first measured dimensions 708. First rear scaling factor 714, therefore, may be 1%. Second ink coverage 705 is greater than first ink coverage 703 and may result in a 2% change in second measured dimensions 710. Further, third ink coverage 707 is a high ink coverage that results in a 4% change in third measured dimensions 712. Second rear scaling factor 716 and third rear scaling factor 718 may be 2% and 4%, respectively.

The disclosed embodiments then may select one of the rear scaling factors to be used as second scaling factor 614. In some embodiments, front ink coverage 720 for the front surface of a sheet may be determined. Front ink coverage 720 may correspond to a low, medium, or high level of ink coverage. The corresponding rear scaling factor is selected to be used as second scaling factor 614 by RIP firmware 290. For example, if front ink coverage 720 is medium, then second rear scaling factor 716 is selected to be used as second scaling factor 614.

In some embodiments, front ink coverage 720 may not correspond exactly to a low, medium, or high ink coverage amount. In these instances, the ink coverage used to generate the rear scaling factors closest to front ink coverage 720 may be used. For example, if front ink coverage 720 is 120% for all four colorants, then this amount is closed to first ink coverage 703 of 80%. Thus, first rear scaling factor 714 may be selected as second scaling factor 614.

In further embodiments, second scaling factor 614 may be interpolated using the rear scaling factors determined for the different ink coverages. For example, front ink coverage 720 may be a specified amount not exactly matching the ink coverages used to determine the rear scaling factors. The ink coverages closest to front ink coverage 720 may be determined. New data points for ink coverages may be determined based on the discrete set of ink coverages used in determining the rear scaling factors. Further, multiple rear scaling factors may be determined for all the levels of ink coverage possible for a sheet of the paper media. For example, if 10 levels of ink coverage are possible for the front surface of the sheet, then 10 rear scaling factors may be interpolated using the measured dimensions from the three target sheets. These 10 levels may be stored at control unit 110 and applied as second scaling factor 614 as selected.

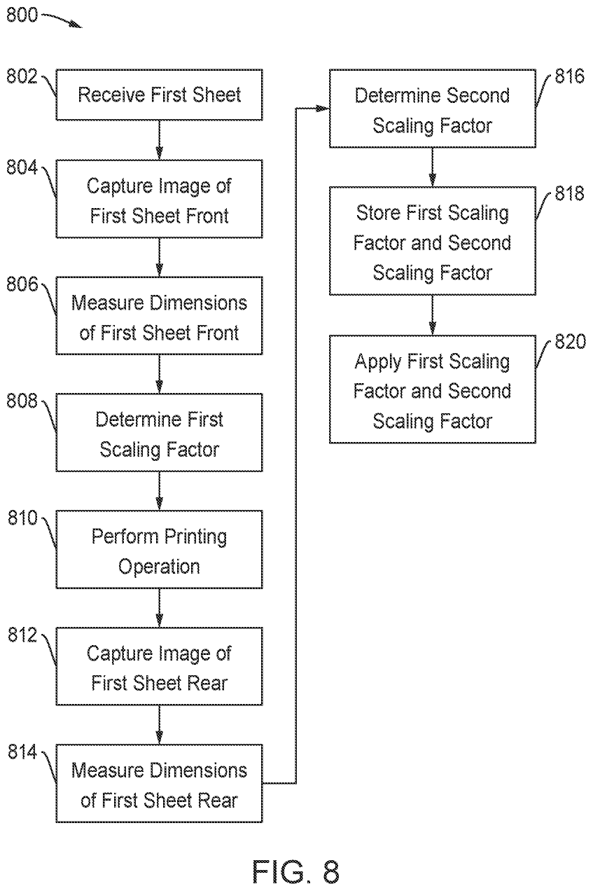

FIG. 8 depicts a flowchart 800 for determining scaling factors for use in printing operations according to the disclosed embodiments. Flowchart 800 may refer to FIGS. 1-7 for illustrative purposes. Flowchart 800, however, is not limited to the embodiments disclosed by FIGS. 1-7.

Step 802 executes by receiving first sheet 604 at printing device 100. First sheet 604 may be a target sheet used to determine scaling factors for a specific paper media. Alternatively, first sheet 604 may be a test sheet of print job 103 that will result in a large number of copies of a document. First sheet 604 includes first sheet front 604F and first sheet rear 604R.

Step 804 executes by capturing an image 605 of first sheet front 604F by inline sensor 602. This image may be used for other operations within printing device 100 and provided to control unit 110. Step 806 executes by measuring dimensions 608L and 608W of first sheet front 604F to determine measured dimensions 611. As disclosed above, dimension 608L may be the length of the sheet and dimension 608W may be the width. Control unit 110 may determine the dimensions using captured image 605 of first sheet front 604F.

Step 808 executes by determining first scaling factor 612 for first sheet 604. First scaling factor 612 applies to the front surface of subsequent sheets corresponding to first sheet 604. First scaling factor 612 reflects the expansion or shrinkage of first sheet front 604F due to the conditions disclosed above, such as the printing device environment, humidity, and the like. For example, measured dimensions 611 may be compared to target dimensions 610 for first sheet 604. Step 810 executes by performing a printing operation using first sheet 604. For example, moving through printing device 100, ink or toner may be applied to first sheet front 604F.

Step 812 executes by capturing image 605 of first sheet rear 604R. After ink or toner is placed on first sheet front 604F, additional expansion or shrinkage of first sheet 604 may occur. Inline sensor 602 captures image 605 of the rear of first sheet 604 to ensure any further change is documented. Step 814 executes by measuring dimensions 608L and 608W of first sheet rear 604R to determine measured dimensions 611, much like step 806 for first sheet front 604F. Step 816 executes by determining second scaling factor 614 for first sheet rear 604R. Second scaling factor 614 reflects the further expansion or shrinkage of first sheet 604 after printing operations are completed. Second scaling factor 614 should differ from first scaling factor 612, but also may be the same.

Step 818 executes by storing first scaling factor 612 and second scaling factor 614 for first sheet 604. In some embodiments, the scaling factors may be stored at control unit 110. In other embodiments, the scaling factors may be stored at a server within the printing system connected to printing device 100. The scaling factors may be retrieved when needed for printing a sheet of paper media related to first sheet 604.

Step 820 executes by applying first scaling factor 612 and second scaling factor 614 to a subsequent sheet of the paper media of first sheet 604. Alternatively, first scaling factor 612 and second scaling factor 614 may be applied to a subsequent sheet of a print job using first sheet 604. The scaling factors may be applied during the RIP process that creates image data 616 to provide to the printing components of printing device 100, such as the print engine. Image data 616 may be scaled so that the items to be printed on the subsequent sheet match the desired dimensions for the print job.

In some embodiments, inline sensor 602 may not be used. The operator may proof first sheet 604 as part of a proof and hold print job. In doing the proofing, measured dimensions 611 may be captured for first sheet front 604F and first sheet rear 604R by the operator or scanning the surfaces of first sheet 604. Determined measured dimensions 611 then are used to determine first scaling factor 612 and second scaling factor 614, which are applied during the RIP process as disclosed above.

In some embodiments having a print job 103 with several sheets, the process disclosed in flowchart 800 may be performed for each sheet so that each sheet has its own scaling factors. The different sheets may receive varying amounts of ink or toner such that dimensions for each sheet may differ. Control unit 110 or external storage may store each set of scaling factors for each sheet and apply them when generating image data 616 from RIP firmware 290.

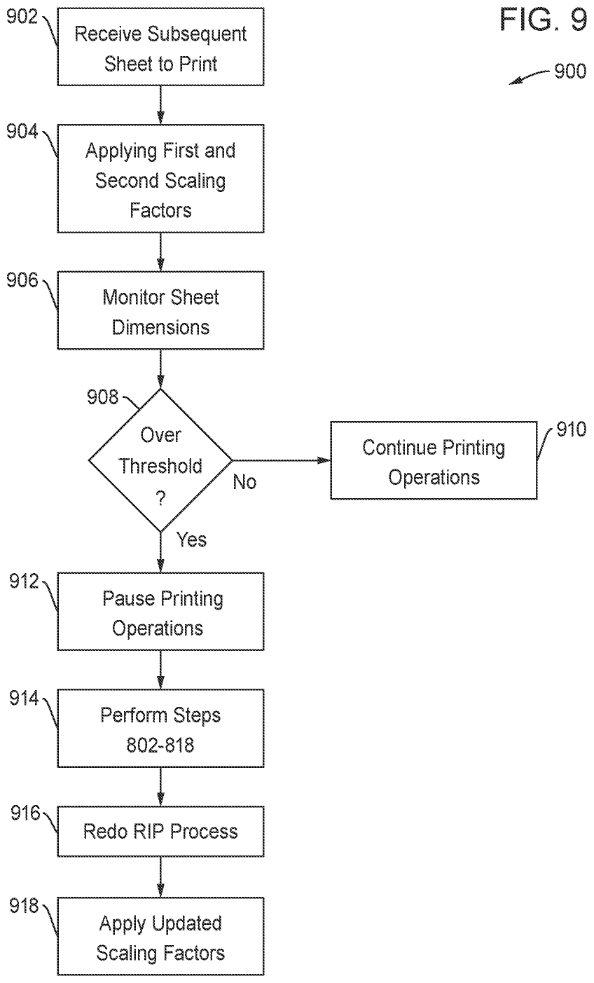

FIG. 9 depicts a flowchart 900 for monitoring the use of scaling factors during printing operations according to the disclosed embodiments. Flowchart 900 may refer to FIGS. 1-8 for illustrative purposes. Flowchart 900, however, is not limited to the embodiments disclosed by FIGS. 1-8.

Step 902 executes by receiving a subsequent sheet to print at printing device 100. For example, second sheet 606 may be a subsequent sheet. The subsequent sheet may be another page within a print job or may be another copy of first sheet 604. For simplicity, second sheet 606 will be referred to below. Step 904 executes by applying first scaling factor 612 and second scaling factor 614 during RIP processing, as disclosed above. First scaling factor 612 and second scaling factor 614 already are determined using the process disclosed in flowchart 800. Image data 616 for second sheet 606 is generated using the scaling factors.

Step 906 executes by monitoring sheet dimensions during printing operations for second sheet 606. As disclosed above, an image 605 may be captured by one or more inline sensors 602 of second sheet 606 as it moves through printing device 100. Images 605 of second sheet front 606F and second sheet rear 606R may be captured. The disclosed embodiments provide images 605 to control unit 110 as part of the monitoring operation. Measured dimensions 611 for each surface of second sheet 606 are determined using the captured images.

Step 908 executes by determining whether measured dimensions 611 are over a threshold. During long print jobs, sheets may change in size even further than when first sheet 604 was used to determine first scaling factor 612 and second scaling factor 614. A threshold may be set, such as expanding or shrinking more than 5%, that triggers a recalculation of the scaling factors. This threshold may be related to target dimensions 610 or measured dimensions 611 used to determine first scaling factor 612 and second scaling factor 614.

If step 908 is no, then second sheet 606 appears to be printed within the acceptable threshold to fit image data 616 scaled by the scaling factors onto second sheet 606 so that it is consistent with the sheets printed beforehand. Thus, step 910 executes by continuing printing operations by printing second sheet 606 and waiting for the next sheet to be analyzed.

If step 908 is yes, then step 912 executes by pausing printing operations. First scaling factor 612 and second scaling factor 614 determined based on first sheet 604 may be no longer applicable to second sheet 606. The size of second sheet 606 changed too much for the scaling factors to be applicable. Step 914 executes by executing steps 802 to 818 as disclosed above to determine updated values for first scaling factor 612 and second scaling factor 614. Steps 802 to 818 are not repeated here for brevity. Control unit 110 may update the scaling factors with the new values. Alternatively, control unit 110 may store the updated scaling factors in a time-based order such that the original scaling factors are still available if needed.

Step 916 executes by redoing the RIP process for print job 103, or second sheet 606. In some embodiments, the remaining pages of print job 103 will be re-RIPped to generate new image data 616 to be used for printing the document. In other embodiments, second sheet 606 may be re-RIPped to print additional copies of the sheet using updated image data 616. Step 918 executes by applying the updated scaling factors during the RIP process to modify the scale applied to image data 616 in order to fit on second sheet 606 to make it consistent.

In some embodiments, the disclosed process may measure dimensions of a subsequent sheet to periodically update scaling factors without determining whether a threshold is exceeded. Thus, not all steps of flowchart 900 need to be executed in updating scaling factors during printing operations. Control unit 110 may request image data for set sheets in the print job or set copies during a print run. The disclosed embodiments provide for updating scaling factors as needed, even while printing device 100 is printing documents.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for performing printing operations, the method comprising:
measuring dimensions of a front surface of first target sheet of a paper media using an inline sensor of a printing device;
determining a first scaling factor for the front surface of the first target sheet based on the measured dimensions of the front surface of the first target sheet;
measuring dimensions of a rear surface of the first target sheet of the paper media using the inline sensor;
determining a second scaling factor for the rear surface of the first target sheet based on the measured dimensions of the rear surface of the first target sheet; and
applying the first scaling factor for the front surface of the first target sheet and the second scaling factor for the rear surface of the first target sheet to a print job using the paper media.

2. The method of claim 1, further comprising storing the first scaling factor and the second scaling factor for the paper media.

3. The method of claim 1, further comprising determining to apply the first scaling factor or the second scaling factor to a subsequent print job using the paper media.

4. The method of claim 1, further comprising performing printing operations for a second target sheet.

5. The method of claim 4, further comprising measuring dimensions of the second target sheet of the paper media using the inline sensor.

6. The method of claim 5, further comprising determining a third scaling factor for the paper media based on the measured dimensions of the second target sheet.

7. The method of claim 1, further comprising printing a sheet of the print job using the first scaling factor for a front surface of the sheet and the second scaling factor for a rear surface of the sheet.

8. The method of claim 7, further comprising determining a final scaling factor based on the printed sheet to adjust inline finishing.

9. The method of claim 1, further comprising processing the print job using a raster image processor (RIP) that applies the first scaling factor and the second scaling factor.

10. The method of claim 1, further comprising:
receiving a subsequent sheet to be printed for a print job using the paper media;
applying the first scaling factor to the front surface of the subsequent sheet and the second scaling factor to the rear surface of the subsequent sheet;
printing the subsequent sheet;
measuring dimensions of the front surface of the subsequent sheet;
measuring dimensions of the rear surface of the subsequent sheet; and
updating the first scaling factor based on the measured dimensions of the front surface of the subsequent sheet or the second scaling factor based on the measured dimensions of the rear surface of the subsequent sheet.

11. The method of claim 10, wherein the front surface of the subsequent sheet has a first ink coverage and a second ink coverage.

12. The method of claim 11, wherein the first ink coverage differs from the second ink coverage.

13. The method of claim 11, wherein determining the second scaling factor for the rear surface of the subsequent sheet includes using the second scaling factor based on the first ink coverage or the second ink coverage.

14. The method of claim 11, further comprising applying the updated first scaling factor to the front surface of the subsequent printed sheet and the updated second scaling factor to the rear surface of the subsequent printed sheet.

15. A method for performing printing operations at a printing device, the method comprising:
processing a print job at a digital front end (DFE) for the printing device by applying a first scaling factor;
monitoring a sheet dimension for a sheet within the print job;
detecting that the sheet dimension does not meet a requirement for the first scaling factor;
pausing processing of the print job;
determining a second scaling factor based on the sheet dimension of the sheet;
resuming processing of the print job; and
applying the second scaling factor at the DFE for processing the print job.

16. The method of claim 15, further comprising measuring the sheet dimension using an inline sensor within the printing device.

17. The method of claim 15, further comprising determining the first scaling factor based on the measured dimensions of an initial sheet of the print job.

18. A method for managing printing operations of a print job, the method comprising:
measuring dimensions of a front surface of a first target sheet of a paper media using an inline sensor of a printing device;
determining a front scaling factor for the front surface of the first target sheet based on the measured dimensions of the front surface of the first target sheet;
printing the first target sheet having a first amount of ink coverage;
determining a first rear scaling factor based on measured dimensions for a rear surface of the first target sheet having the first amount of ink coverage;
printing the first target sheet having a second amount of ink coverage;
determining a second rear scaling factor based on measured dimensions for a rear surface of the first target sheet having the second amount of ink coverage;
storing the front scaling factor, the first rear scaling factor, and the second rear scaling factor; and
applying the front scaling factor for the front surface of a printed sheet and a selected rear scaling factor for the rear surface of the printed sheet based on an ink coverage for the front surface, wherein the first rear scaling factor or the second rear scaling factor is selected based on the ink coverage.

19. The method of claim 18, further comprising interpolating the first rear scaling factor and the second rear scaling factor according the ink coverage for the front surface to determine the selected rear scaling factor.

20. A method for managing printing operations, the method comprising:
printing at least one sheet of a print job at a printing device;
measuring dimensions of a front surface of the at least one sheet;
determining a first scaling factor for the front surface of the at least one sheet based on the measured dimensions of the front surface;
measuring dimensions of a rear surface of the at least one sheet;
determining a second scaling factor for the rear surface of the at least one sheet based on the measured dimensions of the rear surface; and
applying the first scaling factor for the front surface and the second scaling factor for the rear surface of a subsequent copy of the print job at the printing device.
